(19) United States
(12) Patent Application Publication
(10) Pub. No.: US 2009/0312485 A1
(43) Pub. Date: Dec. 17, 2009

(54) UNSATURATED POLYESTER RESIN COMPOSITIONS COMPRISING 1,3-PROPANEDIOL

(75) Inventors: Matthew Arthur Page, Wilmington, DE (US); Hari Babu Sunkara, Hockessin, DE (US); Judith Johanna Van Gorp, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DUPONT DE NEMOURS AND COMPANY, Wilmington, DE (US)

(21) Appl. No.: 12/266,037

(22) Filed: Nov. 6, 2008

Related U.S. Application Data
(60) Provisional application No. 61/060,548, filed on Jun. 11, 2008.

(51) Int. Cl. C08L 67/06; C08G 63/00

(52) U.S. Cl. 524/539; 528/271; 524/599

(57) ABSTRACT

The present invention relates to unsaturated polyester resin (UPR) compositions comprising 1,3-propanediol. The 1,3-propanediol can be renewably-sourced.

### FIELD OF THE INVENTION

The present invention relates to unsaturated polyester resin (UPR) compositions comprising 1,3-propanediol. Both the 1,3-propanediol and the other dialcohol can be renewably-sourced.

### BACKGROUND

Currently-available unsaturated polyester resins are generally based on 1,2-propylene glycol, either alone or in combination with ethylene glycol or other dialcohols, and the shaped articles derived from these composite resins have been used in a variety of end-uses, including marine, automobile, construction, engineered stone, sport and furniture applications, and the like. However, articles made from these materials can exhibit tensile or flex properties at insufficient levels, exhibit less ideal appearance (yellowing), and are generally not made from renewably-based sources.

U.S. Pat. No. 6,555,623 discloses the preparation of unsaturated polyesters containing 2-methyl-1,3-propanediol.

U.S. Pat. Appl. 2008/0154002 discloses molding resins using renewably sourced components.

May, C. A., et al., Modern Plastics, March 1962, pp 144-228, disclose the use of fossil-sourced trimethylene glycol to make unsaturated polyester resins. However, this fossil-sourced trimethylene glycol contains impurities (ditrimethylene glycol and 3-hydroxymethyl-4-hydroxy tetrahydropyran) not present in the renewably sourced 1,3-propanediol. Therefore, these resins suffer from relatively poor performance in many properties, including hardness, flexural strength and elongation, color, and heat distortion point.

The materials disclosed in the references above are not made from renewably-based sources. There is a need for high performance products with reduced environmental impact, especially carbon load on the atmosphere. There is also an environmental advantage for manufacturers to provide products of renewably based sources.

### SUMMARY OF THE INVENTION

One aspect of the present invention is an unsaturated polyester resin composition comprising repeat units having the formula:

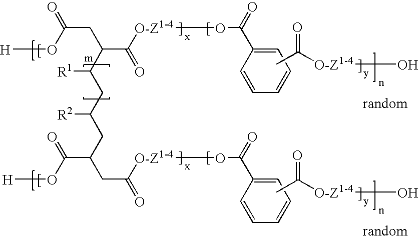

wherein “random” indicates a random copolymer; Z¹-Z⁴ indicates one of Z¹, Z², Z³ and Z⁴ and each of Z¹-Z⁴ is independently selected from the group consisting of: ethylene, 1,2-propylene, 1,3-propylene, diethylene, neopentylene and 2-methyl-1,3-propylene, provided that at least one of Z¹-Z⁴ is propylene from a biologically derived source; each of R¹ and R² is independently selected from benzene, toluene, and methacrylic methyl ester; m is 0 to 5, n is 1 to 100; x+y=n, and the ratio x:y is from 2:1 to 1:2. In preferred embodiments, m is 2 to 3. In other preferred embodiments, n is 8 to 30.

Another aspect of the present invention is an unsaturated polyester composition, comprising a dialcohol, and unsaturated diacid, and at least one saturated diacid. The dialcohols are selected from biologically derived 1,3-propanediol, and mixtures of biologically derived 1,3-propanediol and other dialcohols.

### BRIEF DESCRIPTION OF THE FIGURES/DRAWINGS

FIG. 1 is a graph representing the acid number versus time of three UP syntheses at temperatures between 205 and 215 degrees Celsius.

FIG. 2 is a graph representing the Garner Holdt viscosity versus time of three UP syntheses at temperatures between 205 and 215 degrees Celsius.

FIG. 3 is a graph representing the Garner Holdt viscosity versus acid number of three UP syntheses at temperatures between 205 and 215 degrees Celsius.

FIG. 4 is a graph representing the percentage 1,2-ethylene glycol incorporated in the UP versus time at temperatures between 205 and 215 degrees Celsius.

FIG. 5 is a representation of a ¹H-NMR spectrum of a UP made from biologically derived 1,3-propanediol.

FIG. 6 is a graph representing the isomerization versus time for five UP runs of two UP formulations at temperatures between 205 and 215 degrees Celsius.

FIG. 7 is a graph representing the isomerization versus acid number for five UP runs of two UP formulations at temperatures between 205 and 215 degrees Celsius.

FIG. 8 includes representations of ¹H-NMR spectra of a UP made from biologically derived 1,3-propanediol after treatment at 80° C. in toluene applying different times and levels of piperidine.

### DETAILED DESCRIPTION

The present invention provides, in one embodiment unsaturated polyester resins (UPRs). The UPRs are made from unsaturated polyesters (UPs) comprising renewably-sourced (also referred to as biologically derived or bio-sourced) 1,3-propanediol (1,3-PDO).

The production of the UPs involves the polycondensation of a polyhydric alcohol, an unsaturated diacid, and an aromatic diacid.

The unsaturated polyester can then be reacted with a vinyl monomer to form an unsaturated polyester resin (UPR), which is a crosslinked thermoset resin. Styrene is a preferred vinyl monomer.

In one embodiment, maleic anhydride is used as the unsaturated diacid and the process includes a further reaction; the further reaction is the isomerization of the unsaturated diacid from the cis to the trans form,to render the UP reactive towards vinyl monomers.

In other embodiments, processed compositions of the unsaturated polyester resins are provided, as well as products made from the processed compositions.

UPs contain three types of monomers, including polyhydric alcohols, unsaturated diacids, and aromatic diacids. The unsaturated diacid can contain an aromatic group. Aromatic diacids for use in the UPs include aromatic anhydrides.

A wide variety of polyhydric alcohols can be used in making UPs, including but not limited to ethylene glycol, diethylene glycol, triethylene glycol, propylene glycol, 1,3-propanediol, dipropylene glycol, 1,3-butanediol, 1,4-butanediol, 1,3-hexanediol, neopentyl glycol, 1-methyl-1,3-pentanediol, 2-methyl-1,3-propanediol, 1,3-butylene glycol, 1,6-hexanediol, hydrogenated bisphenol A, cyclohexane dimethanol, 1,4-cyclohexanol, ethylene oxide adducts of bisphenols, propylene oxide adducts of bisphenols, sorbitol, 1,2,3,6-hexanetetrol, 1,4-sorbitan, pentaerythritol, dipentaerythritol, tripentaerythritol, 1,6-hexanediol dipentaerthritol, sucrose, 1,2,4-butanetriol, 1,2,5-pentanetriol, glycerol, 2-methyl-propanetriol, 2-methyl-1,2,4-butanetriol, trimethylol ethane, trimethylol propane, and 1,3,5-trihydroxyethyl benzene. While any of the polyhydric alcohols can be used, preferred ones include dialcohols such as ethylene glycol, 1,2-propylene glycol (1,2-PG), 1,3-propanediol (1,3-PDO), diethylene glycol (DEG), neopentyl glycol (NPG) and 2-methyl-1,3-propanediol (MPDiol). As shown in the embodiments herein, preferred polyhydric alcohols include the dialcohols 1,3-PDO and a mixture of 1,3-PDO with 1,2-PG.

Maleic anhydride is a preferred unsaturated diacid. Examples of other unsaturated diacids that can be used include fumaric acid and itaconic acid and their esterifiable or transesterifiable derivatives.

Aromatic diacids, including anhydrides and esterifiable or transesterifiable derivatives thereof, that find particular use include phthalic anhydride and phthalic acid, more specifically ortho-phthalic anhydride, ortho-phthalic acid, iso-phthalic acid and iso-phthalic anhydride. Other examples include terephthalic acid, dimethyl terephthalate, tetrahydrophthalic anhydride, nadic anhydride, methylnadic anhydride, hexahydrophthalic anhydride, and dimethyl terephthalate.

Examples of vinyl monomers that can be reacted with the UP to form a UPR include unsubstituted and substituted vinyl aromatics, vinyl esters of carboxylic acids, acrylates, methacrylates, hydroxyalkyl acrylates, hydroxyalkyl methacrylates, acrylamides, methacrylamides, acrylonitrile, methacrylonitrile, alkyl vinyl ethers, allyl esters of aromatic di- and polyacids, and the like, and mixtures thereof. Preferred vinyl monomers are vinyl aromatics, halogenated vinyl aromatics, methacrylic acid esters, and diallyl esters of aromatic di- and polyacids. Particularly preferred vinyl monomers are styrene, vinyl toluene, methyl methacrylate, and diallyl phthalate.

The aromatic diacid increases the solubility of the UP in vinyl monomers. Solubility in styrene enables storage, handling, and processing of the UP/vinyl monomer solution. The solution can be stored, and processed later by an end user. The presence of the aromatic diacid is particularly useful in 1,3-PDO-based unsaturated polyesters wherein 1,3-PDO is the sole glycol in the polyester, wherein the aromatic diacid allows the polyester to be soluble (i.e., non-crystalline and non-hazy) in styrene at weight percents between about 60 and 70 percent.

The amount of saturated diacid needed to make the unsaturated polyester soluble is generally expressed as the ratio between the saturated and unsaturated diacids (e.g., phthalic anhydride (PA) to maleic anhydride (MA)). This ratio generally depends on the type of diacid present, as well as the amount and type of diols other than 1,3-PDO present in the reaction. For example, with relatively high levels of maleic anhydride (e.g., PA/MA of 1/1 up to 1/2) less than or equal to about 70 mole percent of 1,3-PDO relative to the total diol amount is appropriate. For a less reactive resin, where the ratio of PA/MA is approximately 1/1, about 80 mole percent or less of 1,3-PDO relative to the total diol amount is appropriate. For even less reactive resins, with a PA/MA ratio of 2/1, 100 mole percent of 1,3-PDO or less relative to the total diol amount is appropriate.

The scheme below exemplifies one embodiment of a process for synthesizing UPR, using maleic acid as the diacid. When the diacids are added to the 1,3-PDO ester groups are formed. In the specific scheme shown, the maleic moiety isomerizes to form a fumaric fragment on the unsaturated polyester molecule formed, as shown below in Step 1.

### Step 1: Production of UP

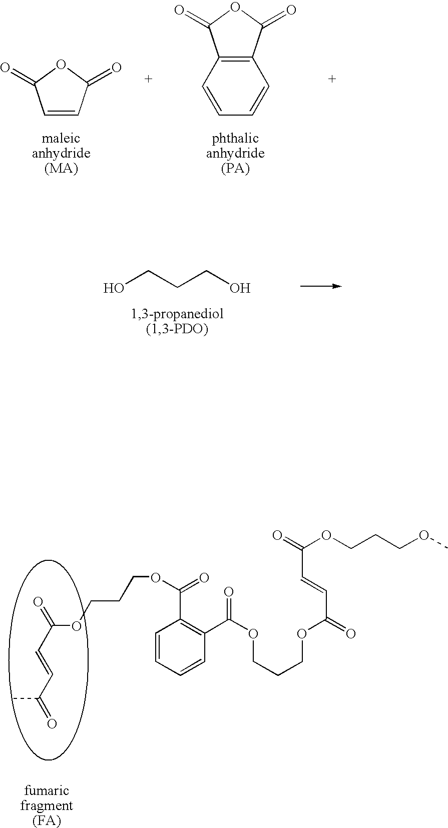

The unsaturated polyester is then combined with styrene, and then crosslinked to form the unsaturated polyester resin as shown in Step 2, after an initiator, and optionally promoters, are added. Initiators that can be used include benzoyl peroxide, methyl ethyl ketone peroxide, and other peroxides. Promoters that can be used include cobalt ligands such as cobalt naphtenate in combination with amines such as Dimethylamine or N,N′-dimethylaniline.

### Step 2: Production of UPR

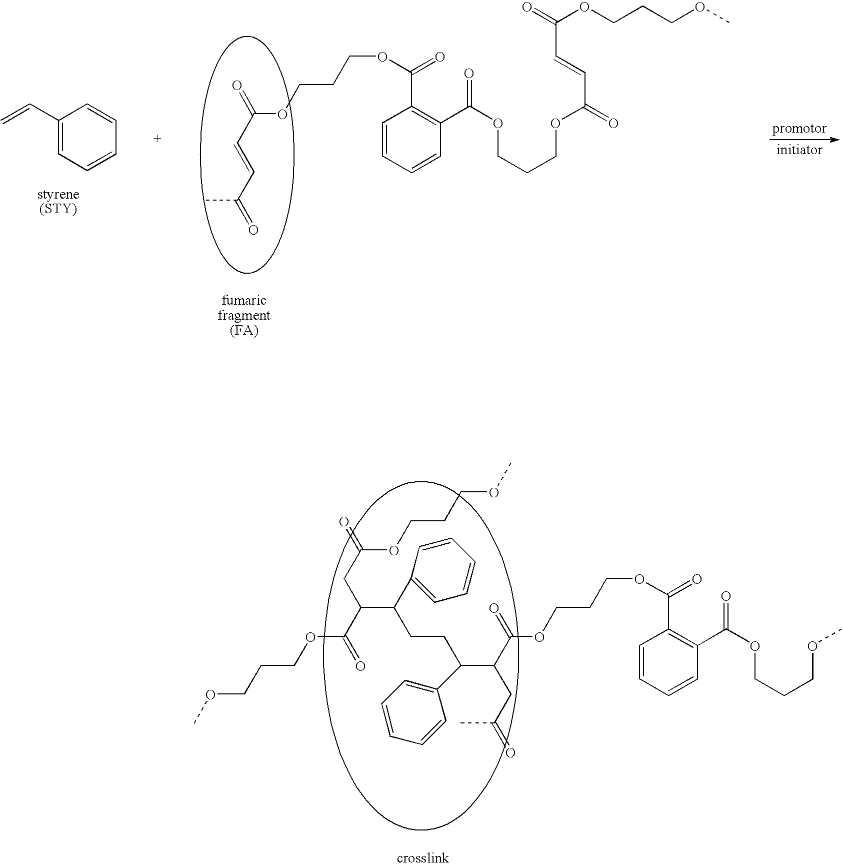

During the reactions described in the steps above (i.e., the “UPR cook”), the use of 1,3-propanediol has several effects. It allows for either shorter batch times or less loss of glycol because its boiling point is higher than that of common glycols such as 1,2-propylene glycol. The two primary hydroxyl groups of 1,3-PDO allow for fast polyesterification while slowing down the viscosity build of the UP during the synthesis. 1,3-PDO decreases the isomerization rate of maleic units to fumaric units in the UP, but the use of additives or varying the process conditions can overcome this decrease in rate, thus preventing a potential negative impact on various end-use properties (e.g., hydrolytic stability). The use of 1,3-propanediol lowers the glass transition (Tg) of the non-crosslinked UP below room temperature (about 25 degrees Celsius), thus rendering it sticky rather than glassy in nature. Also, no differences in viscosity have been observed between UPs based on 1,3-propanediol or those based on 1,2-propylene glycol at 60 weight percent in methylcellosolve or styrene. The UP-styrene solutions appear stable over time. The use of 1,3-propanediol slightly reduces the SPI (Society of Plastics Industry) gel and cure times, and also increases the peak exotherm, as shown in Table 2 in the Examples below.

The use of 1,3-propanediol gives crosslinked UPR casts (end-use materials) that are relatively colorless (i.e., no yellowing observed visually) and relatively optically clear. The Tg's of 1,3-propanediol- and 1,2-propylene glycol-based UPRs are similar as shown in Table 2.

The mechanical properties of articles made of UPRs made with 1,3-propanediol and 1,2-propylene glycol were tested and compared as described below. No differences in Barcol hardness between the UPRs were observed. The UPRs made with 1,3-propanediol showed lower heat deflection temperatures (HDT) of the UPR/styrene thermoset. However, this temperature can be increased if desired by using a lower PA/MA ration and a mixture of 1,3-propanediol and 1,2-propylene glycol. Also, the compressive strength of these compositions was lower, as was the modulus (tensile and flex), while the strength and elongation values at break were higher. Thus, the 1,3-propanediol-based UPR thermosets exhibited less stiffness and were stronger, and less brittle without negatively impacting the hardness.

The unsaturated polyesters of the present invention are useful in various moulding and extruding applications, as well as (gel) coatings. The polyesters can also contain a filler, a reinforcing agent, and/or a thickener. Suitable fillers include calcium carbonate, calcium silicate, silica, clay, talc, glass and quartz. Suitable reinforcing agents include glass fiber, carbon, graphite, and cellulose, nylon, cotton. Suitable thickeners include oxides and/or hydroxides of magnesium, calcium, zinc and the like. In addition, the unsaturated polyester resins can contain pigments, colorants, lubricants, and/or stabilizers.

The 1,3-propanediol used in the processes disclosed herein can be obtained by any of the various well known chemical routes or by biochemical transformation routes. Preferred routes are described in, for example, U.S. Pat. No. 7,098,368.

Preferably, the 1,3-propanediol is obtained biochemically from a renewable source (“biologically-derived” 1,3-propanediol).

A particularly preferred source of 1,3-propanediol is via a fermentation process using a renewable biological source. As an illustrative example of a starting material from a renewable source, biochemical routes to 1,3-propanediol (PDO) have been described that utilize feedstocks produced from biological and renewable resources such as corn feed stock. For example, bacterial strains able to convert glycerol into 1,3-propanediol are found in the species Klebsiella, Citrobacter, Clostridium, and Lactobacillus. The technique is disclosed in several publications, including U.S. Pat. No. 5,633,362, U.S. Pat. No. 5,686,276 and U.S. Pat. No. 5,821,092. U.S. Pat. No. 5,821,092 discloses, inter alia, a process for the biological production of 1,3-propanediol from glycerol using recombinant organisms. The process incorporates E. coli bacteria, transformed with a heterologous pdu diol dehydratase gene, having specificity for 1,2-propanediol. The transformed E. Coli is grown in the presence of glycerol as a carbon source and 1,3-propanediol is isolated from the growth media. Since both bacteria and yeasts can convert glucose (e.g., corn sugar) or other carbohydrates to glycerol, the processes disclosed in these publications provide a rapid, inexpensive and environmentally responsible source of 1,3-propanediol monomer.

The biologically-derived 1,3-propanediol, such as produced by the processes described and referenced above, contains carbon from the atmospheric carbon dioxide incorporated by plants, which compose the feedstock for the production of the 1,3-propanediol. In this way, the biologically-derived 1,3-propanediol preferred for use in the context of the present invention contains only renewable carbon, and not fossil fuel-based or petroleum-based carbon. Thus, the compositions of the present invention can be characterized as more natural and having less environmental impact than similar compositions comprising petroleum based glycols.

The biologically-derived 1,3-propanediol, may be distinguished from similar compounds produced from a petrochemical source or from fossil fuel carbon by dual carbon-isotopic finger printing. This method usefully distinguishes chemically-identical materials, and apportions carbon in the copolymer by source (and possibly year) of growth of the biospheric (plant) component. The isotopes, ¹⁴C and ¹³C, bring complementary information to this problem. The radiocarbon dating isotope (¹⁴C), with its nuclear half life of 5730 years, clearly allows one to apportion specimen carbon between fossil (“dead”) and biospheric (“alive”) feedstocks (Currie, L. A. “Source Apportionment of Atmospheric Particles,” Characterization of Environmental Particles, J. Buffle and H. P. van Leeuwen, Eds., 1 of Vol. I of the IUPAC Environmental Analytical Chemistry Series (Lewis Publishers, Inc) (1992) 3-74). The basic assumption in radiocarbon dating is that the constancy of ¹⁴C concentration in the atmosphere leads to the constancy of ¹⁴C in living organisms. When dealing with an isolated sample, the age of a sample can be deduced approximately by the relationship:

t=(−5730/0.693)In(A/A₀)

wherein t=age, 5730 years is the half-life of radiocarbon, and A and A₀ are the specific ¹⁴C activity of the sample and of the modern standard, respectively (Hsieh, Y., Soil Sci. Soc. Am J., 56, 460, (1992)). However, because of atmospheric nuclear testing since 1950 and the burning of fossil fuel since 1850, ¹⁴C has acquired a second, geochemical time characteristic. Its concentration in atmospheric CO₂, and hence in the living biosphere, approximately doubled at the peak of nuclear testing, in the mid-1960s. It has since been gradually returning to the steady-state cosmogenic (atmospheric) baseline isotope rate (¹⁴C/¹²C) of ca. 1.2×10⁻¹², with an approximate relaxation “half-life” of 7-10 years. (This latter half-life must not be taken literally; rather, one must use the detailed atmospheric nuclear input/decay function to trace the variation of atmospheric and biospheric ¹⁴C since the onset of the nuclear age.) It is this latter biospheric ¹⁴C time characteristic that holds out the promise of annual dating of recent biospheric carbon. ¹⁴C can be measured by accelerator mass spectrometry (AMS), with results given in units of “fraction of modern carbon” (f_{M}). f_{M} is defined by National Institute of Standards and Technology (NIST) Standard Reference Materials (SRMs) 4990B and 4990C, known as oxalic acids standards HOxI and HOxII, respectively. The fundamental definition relates to 0.95 times the ¹⁴C/¹²C isotope ratio HOxI (referenced to AD 1950). This is roughly equivalent to decay-corrected pre-industrial Revolution wood. For the current living biosphere (plant material), f_{M}≈1.1.

The stable carbon isotope ratio (¹³C/¹²C) provides a complementary route to source discrimination and apportionment. The ¹³C/¹²C ratio in a given biosourced material is a consequence of the ¹³C/¹²C ratio in atmospheric carbon dioxide at the time the carbon dioxide is fixed and also reflects the precise metabolic pathway. Regional variations also occur. Petroleum, C₃ plants (the broadleaf), C₄ plants (the grasses), and marine carbonates all show significant differences in ¹³C/¹²C and the corresponding δ¹³C values. Furthermore, lipid matter of C₃ and C₄ plants analyze differently than materials derived from the carbohydrate components of the same plants as a consequence of the metabolic pathway. Within the precision of measurement, ¹³C shows large variations due to isotopic fractionation effects, the most significant of which for the instant invention is the photosynthetic mechanism. The major cause of differences in the carbon isotope ratio in plants is closely associated with differences in the pathway of photosynthetic carbon metabolism in the plants, particularly the reaction occurring during the primary carboxylation, i.e., the initial fixation of atmospheric CO₂. Two large classes of vegetation are those that incorporate the “C₃” (or Calvin-Benson) photosynthetic cycle and those that incorporate the “C₄” (or Hatch-Slack) photosynthetic cycle. C₃ plants, such as hardwoods and conifers, are dominant in the temperate climate zones. In C₃ plants, the primary CO₂ fixation or carboxylation reaction involves the enzyme ribulose-1,5-diphosphate carboxylase and the first stable product is a 3-carbon compound. C₄ plants, on the other hand, include such plants as tropical grasses, corn and sugar cane. In C₄ plants, an additional carboxylation reaction involving another enzyme, phosphenol-pyruvate carboxylase, is the primary carboxylation reaction. The first stable carbon compound is a 4-carbon acid, which is subsequently decarboxylated. The CO₂ thus released is refixed by the C₃ cycle.

Both C₄ and C₃ plants exhibit a range of ¹³C/¹²C isotopic ratios, but typical values are ca. −10 to −14 per mil (C₄) and −21 to −26 per mil (C₃) (Weber et al., J. Agric. Food Chem., 45, 2942 (1997)). Coal and petroleum fall generally in this latter range. The ¹³C measurement scale was originally defined by a zero set by pee dee belemnite (PDB) limestone, where values are given in parts per thousand deviations from this material. The “δ¹³C” values are in parts per thousand (per mil), abbreviated %, and are calculated as follows:

$${δ}^{13} C ≡ \frac{( {}^{13} C / {}^{12} C ) sample - ( {}^{13} C / {}^{12} C ) standard}{( {}^{13} C / {}^{12} C ) standard} \times 1000 \%$$

Since the PDB reference material (RM) has been exhausted, a series of alternative RMs have been developed in cooperation with the IAEA, USGS, NIST, and other selected international isotope laboratories. Notations for the per mil deviations from PDB is δ¹³C. Measurements are made on CO₂ by high precision stable ratio mass spectrometry (IRMS) on molecular ions of masses 44, 45 and 46.

Biologically-derived 1,3-propanediol, and compositions comprising biologically-derived 1,3-propanediol, therefore, may be distinguished from their petrochemical derived counterparts on the basis of ¹⁴C (f_{M}) and dual carbon-isotopic fingerprinting, indicating new compositions of matter. The ability to distinguish these products is beneficial in tracking these materials in commerce. For example, products comprising both “new” and “old” carbon isotope profiles may be distinguished from products made only of “old” materials. Hence, the instant materials may be followed in commerce on the basis of their unique profile and for the purposes of defining competition, for determining shelf life, and especially for assessing environmental impact.

Preferably the 1,3-propanediol used as the reactant to produce unsaturated polyesters, or as a component of the reactant to produce unsaturated polyesters, has a purity of greater than about 99%, and more preferably greater than about 99.9%, by weight as determined by gas chromatographic analysis.

The purified 1,3-propanediol preferably has the following characteristics:

(1) an ultraviolet absorption at 220 nm of less than about 0.200, and at 250 nm of less than about 0.075, and at 275 nm of less than about 0.075; and/or

(2) a composition having CIELAB*a*b* “b*” color value of less than about 0.15 (ASTM D6290), and an absorbance at 270 nm of less than about 0.075; and/or

(3) a peroxide composition of less than about 10 ppm; and/or

(4) a concentration of total organic impurities (organic compounds other than 1,3-propanediol) of less than about 400 ppm, more preferably less than about 300 ppm, and still more preferably less than about 150 ppm, as measured by gas chromatography.

The compositions of the embodiments described herein can be subjected to processes to make various products. Generally, the materials herein described can be processed via casting, molding (sheet molding compounding, bulk molding compounding, resin transfer molding, vacuum injection molding, vacuum assisted resin transfer molding), filament winding, infusion, pultrusion, extrusion, spray-up, hand lay-up, and coating. The processed materials find use in coatings, impregnated resins, gel coats, composites, solid surface materials including engineered or cultured marble and quartz surfaces, engineered stone, and, molded articles. Molded articles include those used in storage tanks, automobile body panels, boat building, tub showers, culture marble, solid surface, polymer concrete, pipes and inner liners for pipeline reconstruction.

### EXAMPLES

### General Procedures

Unsaturated polyesters (UPs) were synthesized in a 5 L, 4 neck round bottom flask, equipped with heating mantle, overhead mechanical stirrer, nitrogen sparge, and Dean-Stark setup with overhead thermometer. The flask was charged with 2-2.5 kg diacidic and dialcohol monomers. The diol was added first, followed by phthalic anhydride, maleic anhydride, and hydroquinone (100 ppm on total weight). An excess glycol of 10 mole % was used. The mixture was slowly heated to 215° C. and water distilled off. At regular intervals, polymer samples of 15 g were drawn from the hot reaction mixture and dissolved in styrene (60 wt %) containing 500 ppm 1,4-naphthoquinone. The conversion of polymerization and isomerization was followed by acid number (titration with 0.1 N KOH in methanol), the Garner Holdt viscosity method (either in letters or in cSt as defined in GH tables), and ¹H-NMR (UP in CDCl₃). Polycondensation was continued until the acid number dropped below 15 and the Garner Holdt viscosity reached N-Q. The mixture was quickly cooled to 145° C., and blended with styrene containing 50 ppm toluhydroquinone. After cooling to room temperature, the solids level was checked, and adjusted to 60 wt %.

Thermal transitions were determined by DSC. Molecular weights followed from SEC measurements of UP solutions in THF with RI detection against styrene calibration. The UP viscosity at 60 wt % in methylcellosolve or styrene was determined by a Brookfield DVIII+rheometer. The rheometer program started with a pre-shear period of 5 min at 250 s−¹. The viscosity was reported as the average of all viscosities recorded at torque values between 10% and 90% encountered in an ascending/descending shear rate cycle from 0.5 to 200 rpm (0.09 and 186 s⁻¹) and back. The estimated specific gravity followed from the ratio of absolute and kinematic viscosity.

A closed mold procedure, using slow curing at elevated temperatures, was used to prepare slabs and cylinders. The closed mold was assembled from two 12 by 12 inch temperglass plates (¼ inch thick), custom Teflon® or carbon steel spacers (1 by ⅛ inch) forming a U shaped gasket, latex tubing (diameter=⅛ inch, wall thickness= 1/16 inch), and binder clips. Silicone mold release agent (SurfaSil™ Siliconizing Fluid, Pierce, Ill.) prevented the cast from sticking to the mold.

After the mold was assembled, a mixture was prepared of a 60 wt % solution of UP in styrene (275 g) and benzoyl peroxide crystals (2.75 g, 1 wt %), prewetted in styrene (2.75 g, 1 wt %). The mixture was divided over two molds, without creating air bubbles. The molds were placed in a convection oven in vertical position at 54° C. for 4 h. After the material had gelled (solidified), but before substantial shrinkage was observed (U-shaped), the clips, spacers, and hose were removed, after which the casts were placed in the convection oven for a cure cycle consisting of a 2 hour period at 82° C., followed by a 1 hour period at 121° C. and a cooling ramp of 80 min to 40° C. The detailed procedure described above prevented cracking of the UPR slabs during preparation.

Type I dogbone shaped bars, as well as rectangular bars (5 by ½ inch) were machined from the 9 by 9 inch slabs using a jet water cooled, programmable cutting device. Ideally, 5 Type I dogbone bars for tensile testing, 5 rectangular bars for flexural testing, and 2 rectangular bars for HDT testing were obtained from one cast. In the below Example III, samples from 2 casts were combined to obtain the above repeats for each reported mechanical data point. Cylindrical shapes were reduced to 1 inch length (5 disks per cylinder) for compression strength measurements.

Physical and mechanical properties were measured following the appropriate ASTM procedures. Investigated properties include SPI gel test (ASTM D7029-04); Barcol hardness (ASTM D2583-07, Model 934-1); tensile strength, modulus, and elongation (ASTM D638-03); flexural strength, and modulus (ASTM D790-03); compression strength (ASTM D695-02a); heat deflection temperature (HDT, ASTM D648-07, at 1.82 MPa/264 psi); and yellowness index (YI, ASTM E313-98).

### Example I

### Conversion & Viscosity Build During UP Synthesis

The above procedures were repeated using 3 different monomer compositions, as summarized in Table 1. Comparative Example A used 1,2-propylene glycol as the dialcohol monomer and is herein referred to as 1,2-PG and recipe UPR-1,2-PG. Example 1 used 1,3-propanediol as the dialcohol monomer and is herein referred to as 1,3-PDO and recipe UPR-1,3-PDO. Example 2 used 80 weight percent 1,3-propanediol and 20 weight percent 1,2-propylene glycol as the dialcohol monomer, and is herein referred to as recipe UPR-80/20 mix. Recipe UPR-1,2-PG and UPR-1,3-PDO are based on a ratio of phthalic anhydride and maleic anhydride (PA/MA) of 1.2/0.8. The PA/MA ratio of recipe UPR-80/20 mix is 1/1.

TABLE 1
Overview of UP Recipes

| | | UPR Description | | |
|---|---|---|---|---|
| | | | | Example 2 |
| | | | Example 1 | UPR- |
| | | Comp. Ex. A | UPR-1,3- | 80/20 |
| Monomer | Unit | UPR-1,2-PG | PDO | mix |
| o-Phthalic Anhydride | mole eq. | 1.2 | 1.2 | 1.0 |
| Maleic Anhydride | mole eq. | 0.8 | 0.8 | 1.0 |
| Susterra ™ 1,3-PDO | mole eq. | 0 | 2.2 | 1.76 |
| 1,2-PG | mole eq. | 2.2 | 0 | 0.44 |

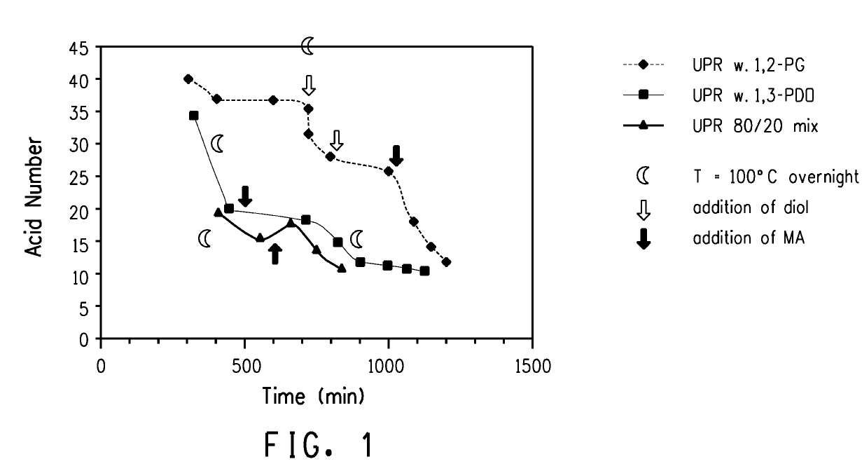

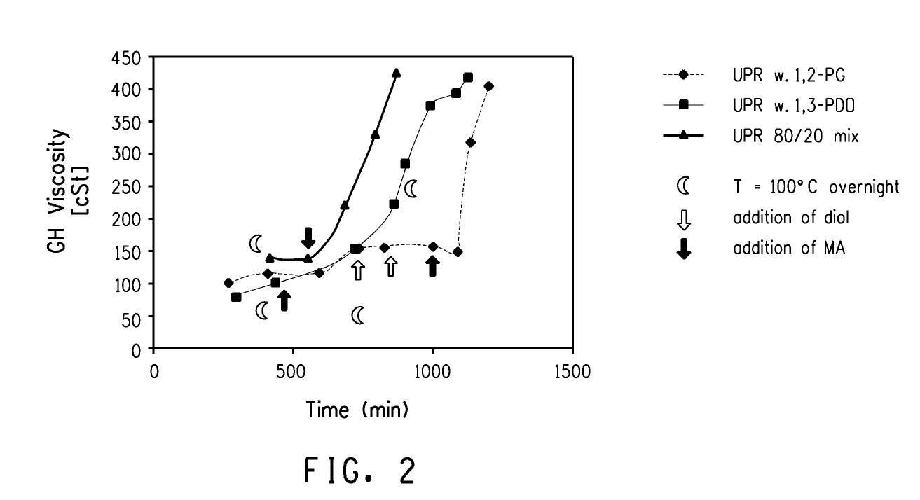

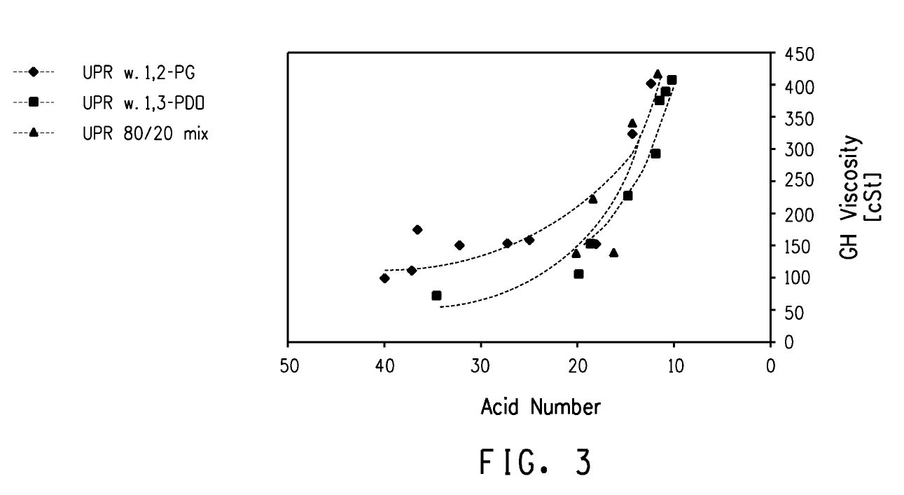

The conversion of the three UP polycondensations was followed over time by acid number (AN) and Garner Holdt viscosity (GH visc.). In recording time, overnight periods during which the temperature was dropped from 215° C. to 100° C. were omitted (yellow moons in FIG. 1 and FIG. 2). Monomer adjustments are indicated by block arrows, open ones for diol additions, and closed ones for maleic anhydride additions. Temperature changes and monomer transitions appear as changes of slope or as ‘jumps’ in the plots ‘AN vs. time’ or ‘GH visc. vs. time’. Temperature and monomer adjustments are not observed when plotting AN versus GH visc. (FIG. 3).

The AN of UPR-1,3-PDO and UPR-80/20 mix dropped much faster than that of UPR-1,2-PG. In a similar fashion, the viscosity raise over time was slower for UPR-1,2-PG. The reaction time for UPR-80/20 mix was much shorter than that of the other two examples to reach the same low AN (<15) and high GH visc. (N-Q). In UP mixtures of higher AN, 1,2-PG induced increased GH visc.'s. At lower AN's (→10), the GH visc. shows a sharp increase for all recipes.

### Example II

### Composition Drift in Recipe UPR-80/20 Mix

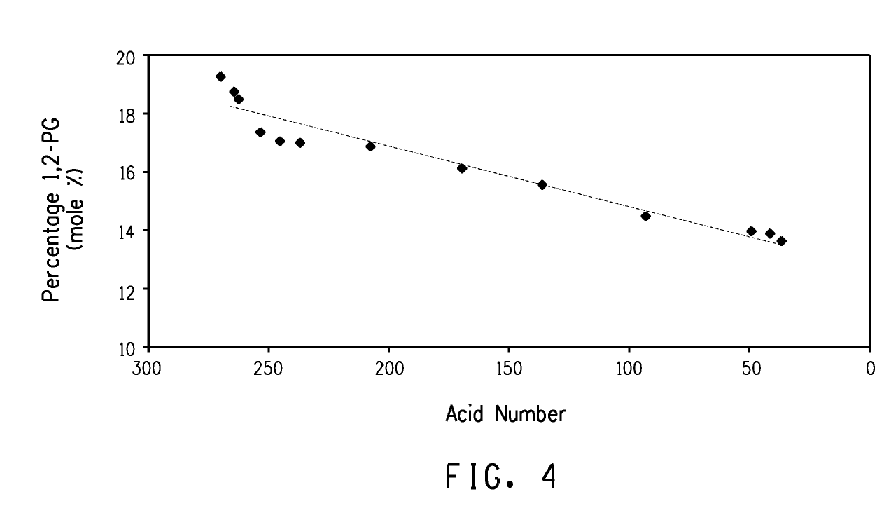

During the synthesis of Example 3 (recipe UPR-80/20 mix, 1,3-PDO sourced from Aldrich) a composition drift was observed. This drift was quantified by the integrals of the ¹H-NMR signals at 1.2-1.4 ppm (1,2-PG) and 1.8-2.1 ppm (1,3-PDO) according to the formula Percentage_{1,2-PG}=Integral_{1,2-PG}/(Integral_{1,2-PG}+Integral_{1,3-PDO}). The diol composition dropped considerably from PDO/PG=80/20 at the beginning of the cook, to PDO/PG=86/14 at the end (7 h), as depicted in FIG. 4. This illustrates how less 1,3-PDO was lost from the reaction mixture because its boiling point is higher than that of common glycols, such as 1,2-PG.

### Example III:

### Properties of Comparative Example A, and Examples 1-2

The above compositions (Example I) were tested for reactivity, physical, and mechanical properties, resulting in the data collected in Table 2. Again, Comparative Example A (UPR-1,2-PG) used 1,2-propylene glycol (1,2-PG) as the dialcohol monomer. Example 1 (UPR-1,3-PDO) used 1,3-propanediol (1,3-PDO) as the dialcohol monomer. Example 2 (UPR-80/20 mix) used 80 weight percent 1,3-propanediol and 20 weight percent 1,2-propylene glycol as the dialcohol monomer. Comparative Example A and Example 1 are based on a ratio of phthalic anhydride and maleic anhydride (PA/MA) of 1.2/0.8. The PA/MA ratio of Example 2 is 1/1.

The use of 1,3-propanediol lowered the glass transition (T_{g}) of the non-crosslinked UP below room temperature (about 25 degrees Celsius), thus rendering it sticky rather than glassy in nature. No significant differences in viscosity were observed between UPs based on 1,3-propanediol or those based on 1,2-propylene glycol at 60 weight percent in methylcellosolve or styrene. The UP-styrene solutions appeared stable over time. Their absolute viscosity did not change significantly over a three month period. The use of 1,3-propanediol slightly reduced the SPI gel and cure times, and also increased the peak exotherm, as shown in Table 2.

The use of 1,3-propanediol gave crosslinked UPR casts (end-use materials) that were relatively colorless (i.e., no yellowing observed) and relatively optically clear. The T_{g}'s of 1,3-propanediol- and 1,2-propylene glycol-based UPRs were similar. No differences in Barcol hardness between the UPRs were observed. The UPRs made with 1,3-propanediol showed lower heat deflection temperatures (HDT) of the UPR/styrene thermoset. However, this temperature was increased by using a lower PA/MA ratio and a mixture of 1,3-propanediol and 1,2-propylene glycol. Also, the compressive strength of these compositions was lower, as was the modulus (tensile and flex). However, the strength and elongation values at break were higher. Thus, the 1,3-propanediol-based UPR thermosets exhibited less stiffness and were stronger and less brittle without negatively impacting the hardness.

TABLE 2
Overview of UPR Properties

| | | UPR Description | | |
|---|---|---|---|---|
| | | Comp. Ex. A | Example 1 | Example 2 |
| Property | Unit | UP-1,2-PG | UP-1,3-PDO | UP-80/20 mix |
| o-Phthalic Anhydride | mole eq. | 1.2 | 1.2 | 1.0 |
| Maleic Anhydride | mole eq. | 0.8 | 0.8 | 1.0 |
| Susterra ™ 1,3-PDO | mole eq. | 0 | 2.2 | 1.76 |
| 1,2-PG | mole eq. | 2.2 | 0 | 0.44 |

Analysis

| | | | | |
|---|---|---|---|---|
| Acid Number | mg_{KOH}/g | 12 | 10 | 11 |
| Molecular Weight Mₙ | g/mol | 2285 | 2554 | 4572 |
| Molecular Weight M_{w} | g/mol | 8094 | 9454 | 15088 |
| Polydispersity DP | | 3.5 | 3.7 | 3.3 |
| Isomerization | % | 96 | 91 | 90 |
| Glass Transition T_{g} | ° C. | 33 | 0.25 | 6.9 |
| Viscosity, 60 wt % in | cP | 366 ± 2.7 | 375 ± 2.2 | 774 ± 5.4 |
| methylcellosolve | | | | |

UP at 60 wt % in styrene - initial

| | | | | |
|---|---|---|---|---|
| Solids Level | wt % | 61 | 59.9 | 59.7 |
| Garner Holdt Viscosity | — | P* | P²-Q* | P-Q* |
| Kinematic Viscosity | cSt | 409* | 393* | 425* |
| Absolute Viscosity | cP | 316 ± 2.6 | 358 ± 2.5 | 660 ± 4.9 |
| Calc. Spec. Grav. | g/mL | 0.77* | 0.91* | 1.55* |

UP at 60 wt % in styrene - repeat after 3 months

| Garner Holdt Viscosity | — | J-K | K-L | S²-T |
|---|---|---|---|---|
| Kinematic Viscosity | cSt | 288 | 295 | 528 |
| Absolute Viscosity | cP | 327 ± 3.0 | 351 ± 3.3 | 602 ± 6.0 |
| Calc. Spec. Grav. | g/mL | 1.14 | 1.19 | 1.14 |
| | | UPR Description | | |
| | | Comp. Ex. A | Example 1 | Example 2 |
| Property | Unit | UPR-1,2-PG | UPR-1,3-PDO | UPR-80/20 mix |
| o-Phthalic Anhydride | mole eq. | 1.2 | 1.2 | 1.0 |
| Maleic Anhydride | mole eq. | 0.8 | 0.8 | 1.0 |
| Susterra ™ 1,3-PDO | mole eq. | 0 | 2.2 | 1.76 |
| 1,2-PG | mole eq. | 2.2 | 0 | 0.44 |

Reactivity at 60 wt % in styrene using 1 wt % BPO crystals

| | | | | |
|---|---|---|---|---|
| SPI gel time | min:sec | 3:47 ± 0:08 | 3:39 ± 0:03 | 3:08 ± 0:06 |
| SPI cure time | min:sec | 3:19 ± 0:02 | 2:24 ± 0:04 | 1:45 ± 0:03 |
| SPI total time | min:sec | 7:06 ± 0:08 | 6:03 ± 0:01 | 4:53 ± 0:03 |
| SPI exotherm | ° C. | 195.1 ± 2.1 | 215.2 ± 0.2 | 230.6 ± 0.6 |

Physical Properties (crosslinked at 60 wt % with styrene using 1 wt % BPO crystals)

| | | | | |
|---|---|---|---|---|
| Yellowness Index YI | — | 5.97 ± 0.10 | 1.61 ± 0.10 | 2.10 ± 0.16 |
| mp and ΔH | ° C., J/g | −44.1, 0.090 | none observed | −45.0, 0.087 |
| Glass Transition T_{g} | ° C. | −19.7, 86.3 | −19.3, 85.1 | −19.4, 110.8 |

Mechanical Properties (crosslinked at 60 wt % with styrene using
1 wt % BPO crystals)

| | | | | |
|---|---|---|---|---|
| Barcol Hardness | − | 64.9 ± 1.5 | 63.8 ± 1.8 | 65.0 ± 1.4 |
| Heat Deflection | ° C. | 75.2 ± 0.42 | 67.2 ± 0.90 | 91.4 ± 0.71 |
| Temperature | | | | |
| Tensile strength | MPa^{@} | 44.4 ± 2.8 | 70.0 ± 2.2 | 50.7 ± 5.9 |
| Tensile modulus | MPa | 3,866 ± 341 | 3,223 ± 282 | 3,810 ± 200 |
| Elongation | % | 1.21 ± 0.16 | 2.88 ± 0.20 | 1.57 ± 0.26 |
| Flexural strength | MPa | 67.1 ± 5.6 | 112.7 ± 6.5 | 95.9 ± 7.4 |
| Flexural modulus | MPa | 4,161 ± 164 | 3,548 ± 177 | 3,638 ± 187 |
| Compressive strength | MPa | 131.3 ± 4.2 | 103.7 ± 3.3 | 112.7 ± 1.5 |

*Values do not correspond with molecular weight data
^{@}1 Mpa = 1.45 kpsi

### Example IV

### Formulation Studies

The above general procedure for UP synthesis was repeated with different monomer compositions. The 60 wt % styrene solutions of these UPs were tested for their stability over time (clear solution, no gel or haziness). Both phthalic anhydride (ortho-resins)and iso-pthalic acid (iso-resins) were used. Results are collected in Table 3. Thus, the maximum level of 1,3-PDO incorporation for resins with varying reactivity (ratio of phthalic and maleic groups PA/MA) was determined. For 1,3-PDO based “ortho resins” with relatively high levels of maleic anhydride (e.g., PA/MA of 1/1 up to 1/1.5) less than or equal to about 70 mole percent of 1,3-PDO relative to the total diol amount is appropriate. For a less reactive resin, where the ratio of PA/MA is approximately 1/1, less than or equal to about 80 mole percent of 1,3-PDO relative to the total diol amount is appropriate. For even less reactive resins, with a PA/MA ratio of 1.5/1, less than or equal to about 100 mole percent of 1,3-PDO relative to the total diol amount is appropriate. In case of “iso resins” PA/MA ratios of 1/1.5 to 1/1 are appropriate in combination with less than or equal to about 80 mole percent of 1,3-PDO relative to the total diol amount.

TABLE 3
Examples of Formulations Stable at 60 wt % in Styrene
Ortho-Resins

| | | | 1,3-PDO/ | Stability |
|---|---|---|---|---|
| Example | Reactivity | oPA/MA | 1,2-PG | (clear solution) |
| Example 4 | High | 1/1.5 | 7/3 | at least 2 months |
| Example 5 | Intermediate | 1/1 | 8/2 | at least 2 months |
| Example 1 | Low | 1.5/1 | 10/0 | at least 2 months |

Iso-Resins

| | | | 1,3-PDO/ | Stability |
|---|---|---|---|---|
| Example | Reactivity | iPA/MA | 1,2-PG | (clear solution) |
| Example 6 | High | 1/1.5 | 8/2 | at least 3 weeks |
| Example 7 | Intermediate | 1/1 | 8/2 | at least 5 weeks |
| Example 8 | Low | 1.5/1 | 10/0 and 8/2* | no stable solution |

*Solution gelled during dissolution (8/2) or overnight (10/0)

### Example V

### Thermal Transitions of UPs

DSC data of the unsaturated polyesters (non-crosslinked) in Example III (Composition UP-1,2-PG, UP-1,3-PDO, and UP-80/20 mix) were repeated for different runs of the same composition, as recorded in Table 4.

In Table 4, the following abbreviations and explanations apply. ‘Old’ indicates a synthetic set-up that deviates slightly from the general procedure above with respect to order of addition, water removal and water/glycol separation. ‘New’ indicates a synthetic set-up as described above. “a” and “b” are run numbers. ‘A’ indicates use of fossil-based 1,3-PDO from Aldrich, ‘L’ means renewably sourced Susterra™ 1,3-PDO from DuPont Tate&Lyle, Loudon, TN. All ‘new’ runs are performed with Susterra™ 1,3-PDO. A “*” indicates data measured on different SEC column, optimal for determining low molecular weight material.

The difference in T_{g} between Comparative Example A (T_{g}=33-36° C.) and Example 1 (T_{g}=0-2° C.) was about 33° C. and caused by a difference in monomer composition (1,2-PG and 1,3-PDO, respectively). The difference in T_{g} of the two runs of recipe UP-80/20 mix (Example 2 and 14) was 4° C. and is induced by a difference in molecular weight. This example confirms that the effect of monomer composition on the T_{g} is larger than the effect of variations in production method, monomer source, isomerization level, acid number, viscosity or molecular weight encountered in this study.

TABLE 4
DSC of UPs

| Ex. | Recipe | Method | Run | AN | GH visc. | Mₙ [g/mol] | Iso.[%] | T_{g} [° C.] |
|---|---|---|---|---|---|---|---|---|
| 9 | UP-1,2-PG | Old | | 26 | not det. | 2793 | 97 | 36 |
| A | UP-1,2-PG | New | a | 12 | P | 2285 | 96 | 33 |
| 10 | UP-1,2-PG | New | b | 18 | Q-R | 1272* | 98 | 36 |
| 11 | UP-1,3-PDO | Old | A | 8.5 | Not det. | 2226 | 77 | −1.2 |
| 12 | UP-1,3-PDO | Old | L | 24 | not det. | 1694 | 73 | 1.2 |
| 1 | UP-1,3-PDO | New | a | 10 | P²-Q | 2554 | 91 | 0.25 |
| 13 | UP-1,3-PDO | New | b | 11 | P-Q | 1558* | 92 | 0.54 |
| 14 | UP-80/20 mix | Old | L | 46 | not det. | 1766 | 70 | 2.9 |
| 2 | UP-80/20 mix | New | a | 11 | P-Q | 4572 | 90 | 6.9 |

### Example VI

### Thermal Transitions of UPRs

This example aims to capture more details regarding the DSC data of cured UPR Examples Comparative A, 1, and 2, as listed in Table 2. In the first heating run of Comparative Ex. A (UPR-1,2-PG), crosslinked at 60 wt % with styrene and 1 wt % BPO (benzoyl peroxide) crystals, three transitions were observed (Table 5). All of them were T_{g}'s, at −20, 60, and 83° C., respectively. In the second heating run, the T_{g} at 60° C. was no longer observed, and a very low energy melt transition appeared at −44° C. The crosslinked product Example 1 (UPR-1,3-PDO) showed a similar pattern of thermal transitions. One exception was that the low energy melt transition was not observed in Example 1 (UPR-1,3-PDO). It was present, however, in the second heating run of crosslinked Example 2 (UPR-80/20 mix) at −45° C. The first T_{g} had a similar value for all three materials (−18 to −20° C.). The second T_{g} was lower in Example 1 (UPR-1,3-PDO) (53° C.) than in the 1,2-PG containing materials (58-60° C.). The third T_{g} clearly increased from the first to the second run, and was significantly higher in Example 2 (UPR-80/20 mix) (111 vs. 85-86° C.).

TABLE 5
DSC of cured product (60 wt % in styrene, 1 wt % BPO crystals).

| | | First heat | | Second heat | |
|---|---|---|---|---|---|
| | | T_{g}/ | | T_{g}/ | |
| Example | UPR recipe | mp [° C.] | ΔH [J/g] | mp [° C.] | ΔH [J/g] |
| Comp. | UPR-1,2-PG | −19.93 | | −44.06 | 0.09028 |
| Ex. A | | 59.78 | | −19.70 | |
| | | 83.37 | | 86.28 | |
| 1 | UPR-1,3- | −18.41 | | −19.30 | |
| | PDO | 52.89 | | | |
| | | 80.19 | | 85.05 | |
| 2 | UPR-80/20 | −18.15 | | −45.02 | 0.08708 |
| | mix | 58.04 | | −19.35 | |
| | | 96.93 | | 110.83 | |

### Example VII

### Cis-Trans Isomerization

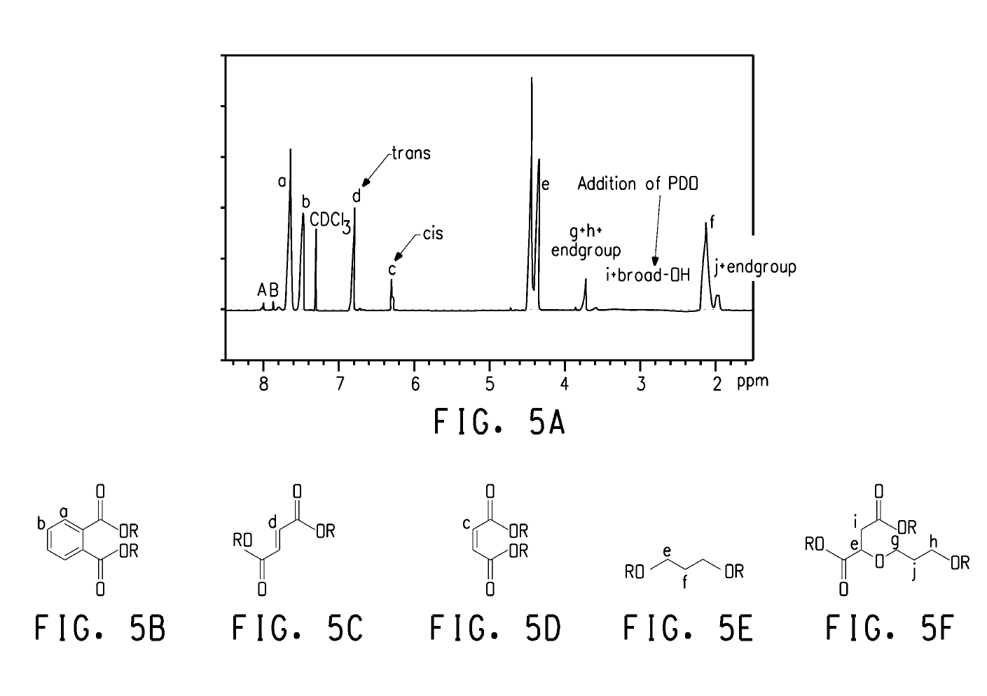

Isomerization from cis maleic to trans fumaric groups of the three UP Examples in Example I was followed over time during the UP syntheses. The trans/cis ratio was determined by the ratio of the integrals of the signals at 6.9 (fumaric) and 6.2 (maleic) ppm in ¹H-NMR (FIG. 5A). The Isomerization value (Iso.) in [%] is expressed as {Integral trans (6.9 ppm)}/[Integral trans (6.9 ppm)+Integral cis (6.2 ppm)]}. Assignments of the protons are depicted in FIG. 5B through 5F. Signals belonging to succinic protons, resulting from Ordelt addition of the diol to the fumaric double bond are identified (FIG. 5A, signals g-j and FIG. 5F).

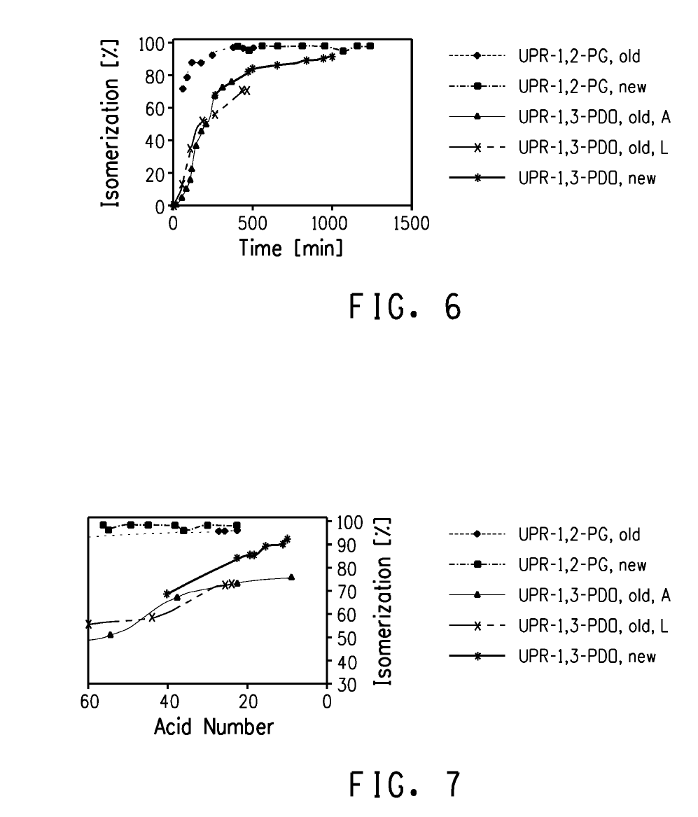

FIG. 6 and FIG. 7 show two runs for recipe UPR-1,2-PG (Example 9 and 10) and three runs for recipe UP-1,3-PDO (Example 11, 12, and 13). Details of Example 9-13 are described under Example V and in Table 4.

Isomerization occurred much faster in presence of 1,2-PG than when 1,3-PDO was used. After enough time, however, the isomerization level in UP-1,3-PDO materials (91%) reached an equilibrium value similar to that of UP-1,2-PG polymers (96%). Notable was the overlap of ‘Iso vs time’ curves of both the various runs of material UP-1,2-PG and of material UP-1,3-PDO. This confirmed that the effect of monomer composition on the isomerization rate was larger than the effect of production method, monomer source, acid number, viscosity or molecular weight encountered in the examples tested.

### Example VIII

### One and Two Step Procedures

Synthetic procedures were compared to maximize the isomerization level of the produced UP. The recipe used was UP-1,3-PDO (see Table I). Example 1 was prepared via a one step process as described in the general procedures. Its isomerization level was 91 %, obtained after a reaction time of 18 h (1120 min), at a Mₙ of 2554 g/mol and an AN of 10. Example 15 was prepared in a 2-step process. First, phthalic anhydride (PA) (0.3 mole eq.) was reacted in an excess Susterra™ PDO (1.43 mole eq.) to form the corresponding diester with alcohol endgroups. Next, these alcohol groups were reacted with maleic anhydride (MA) (1 mole eq.). After 7 h (420 min) of total process time, an AN of 20 and Mₙ of 4720 g/mol were reached. The isomerization level was 75%. Therefore, a one-step process as in Example 1 was preferred for obtaining high isomerization levels.

### Example IX

### Isomerization Additives

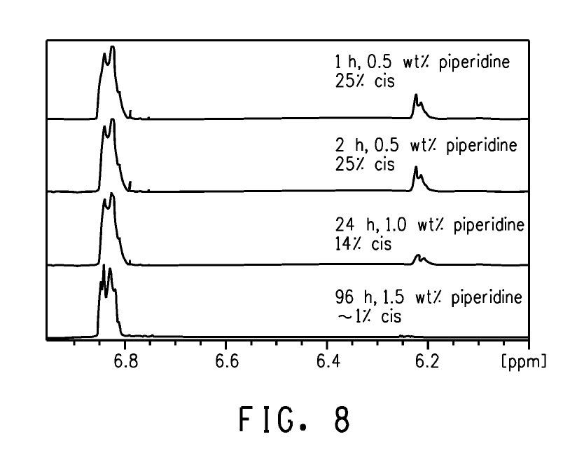

The unsaturated polyester Example 12 (recipe UP-1,3-PDO) with an isomerization level of 73% was treated with base (0.5-1.5 wt %) in toluene (30 wt %) for 96 hours. In Example 16, UP Ex. 12 was treated with morpholine. Example 17 used piperidine as the base. Both bases brought the isomerization in UP Ex. 12 almost to completion (95% for Ex. 16, and 99% for Ex. 17). ¹H-NMR spectra that follow the reaction Example 17 over time are shown in FIG. 8.

### Example X

### Hydrolytic Stability

Open mold casts were prepared at room temperature by crosslinking UPs at 60 wt % solution in styrene. Cure was induced with cobalt naphthenate, <10 wt % (0.27 wt %), and Luperox DDM-9, ˜35 wt % 2-butanoneperoxide (1 wt %). Half of the UP/styrene product was mixed with the promotor, and half with the initiator, after which both were homogenized and poured in a flat dish. After 1 day or longer, sample strips (1×5 cm) were cut, boiled in Dl water for 24 h, and visually inspected (Table 6). Recipes include Comparative Example A (UPR-1,2-PG), Example 11 (as defined in Table 4), and Example 18 (composition UPR-1,3-PDO, isomerization level=99%, prepared with fumaric acid). This experiment indicates that UPR's containing 1,3-PDO show good hydrolytically stability providing they show sufficient isomerization.

TABLE 6
Hydrolytic stability of open mold casts

| | Mₙ | Iso. | Appearance | |
|---|---|---|---|---|
| UPR recipe | (g/mol) | [%] | Top* | Bottom* |
| Comp. Ex A | 2793 | 97 | rough, opaque | fine surface cracks |
| | | | surface | |
| Example 11 | 2226 | 77 | opaque, | opaque, bubbles (1 h) |
| | | | bubbles (1 h) | |
| Example 18 | 2716 | 99 | smooth surface | fine surface cracks |

*Top = side cured on air, Bottom = side cured on aluminium tray

What is claimed is:

1. An unsaturated polyester resin composition comprising repeat units having the formula: 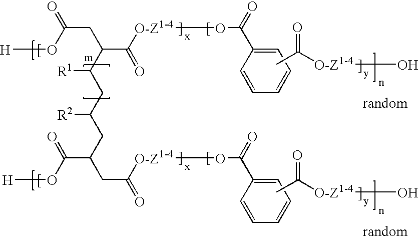
wherein “random” indicates a random copolymer; Z¹-Z⁴ indicates one of Z¹, Z², Z³ and Z⁴ and each of Z¹-Z⁴ is independently selected from the group consisting of: ethylene, 1,2-propylene, 1,3-propylene, diethylene, neopentylene and 2-methyl-1,3-propylene, provided that at least one of Z¹-Z⁴ is propylene from a biologically derived source; each of R¹ and R² is independently selected from benzene, toluene, and methacrylic methyl ester; m is 0 to 5, n is 1 to 100; x+y=n, and the ratio x:y is from 2:1 to 1:2.

2. The unsaturated polyester resin composition of claim 1, wherein said resin exhibits tensile strength greater than 45 Mpa.

3. The unsaturated polyester resin composition of claim 1, wherein said resin exhibits flexural strength greater than 70 MPa.

4. An unsaturated polyester resin composition, comprising biologically derived 1,3-propanediol, an unsaturated diacid, and at least one aromatic diacid.

5. The unsaturated polyester resin composition of claim 4, further comprising an additional dialcohol.

6. The unsaturated polyester resin composition of claim 5, wherein the additional dialcohol is selected from the group consisting of 1,2-propylene glycol, 1,3-propanediol, ethylene glycol, diethylene glycol, dipropyleneglycol, neopentyl glycol, 2-methyl-1,3-propanediol, 2,2-dimethy-1,3-propanediol, 1,3-butanediol, and 1,4-butanediol and mixtures thereof.

7. The unsaturated polyester resin composition of claim 5, wherein the additional dialcohol comprises 1,3-propanediol and 1,2-propylene glycol in a mole ratio between about 100:0 to about 50:50 of 1,3-propanediol:1,2-propylene glycol.

8. The unsaturated polyester resin composition of claim 4, wherein the unsaturated diacid is maleic anhydride.

9. The unsaturated polyester resin composition of claim 4, wherein the saturated diacid is ortho-phthalic acid, iso-phthalic acid, or mixtures thereof.

10. The unsaturated polyester resin composition of claim 4, wherein the aromatic diacid is ortho-phthalic acid, iso-phthalic acid, or mixtures thereof, the unsaturated diacid is maleic anhydride, and the dialcohol comprises biologically derived 1,3-propanediol, 1,2-propyleneglycol, or mixtures of 1,3-propanediol and 1,3-propyleneglycol in a ratio of 100:0 to 20:80.

11. The unsaturated polyester resin composition of claim 10, wherein the aromatic diacid is ortho-phthalic acid, the ortho-phthalic acid/maleic anhyride ratio is 1/1 and the dialcohol comprises 1,3-propanediol/1,2-propylene glycol in a ratio of 80/20 to 20/80.

12. The unsaturated polyester resin composition of claim 10, wherein the aromatic diacid is ortho-phthalic acid, the ortho-phthalic acid/maleic anhydride ratio is 2/1 and the dialcohol compromises 1,3-propanediol/1,2-propylene glycol in a ratio of 100/0 to 20/80.

13. The unsaturated polyester resin composition of claim 10, wherein the aromatic diacid is ortho-phthalic acid, the ortho-phthalic acid/maleic anhydride ratio is 1/2 and the dialcohol comprises 1,3-propanediol/1,2-propylene glycol in a ratio of 70/30 to 20/80.

14. The unsaturated polyester resin composition of claim 10, wherein the aromatic diacid is iso-phthalic acid, the iso-phthalic acid/maleic anhydride ratio is 1/1 and the dialcohol comprises 1,3-propanediol/1,2-propylene glycol in a ratio of 80/20 to 20/80.

15. The unsaturated polyester resin composition of claim 10, wherein the aromatic diacid is iso-phthalic acid, the iso-phthalic acid/maleic anhydride ratio is 2/1 and the dialcohol comprises 1,3-propanediol/1,2-propylene glycol in a ratio 70/30 to 20/80.

16. The unsaturated polyester resin composition of claim 10, wherein the aromatic diacid is iso-phthalic acid, the iso-phthalic acid/maleic anhydride ratio is 1/2 and the dialcohol comprises 1,3-propanediol/1,2-propylene glycol in a ratio of 100/0 to 20/80.

17. A composite comprising the composition of claim 1, 2, or 3.

18. A gel coat comprising the composition of claim 1, 2, or 3.

19. A shaped article comprising the composition of claim 1, 2, or 3.

20. Engineered stone comprising the composition of claim 1, 2, or 3.

21. An impregnated resin comprising the composition of claim 1, 2, or 3.
